(19) United States
(12) Patent Application Publication
(10) Pub. No.: US 2023/0034726 A1
(43) Pub. Date: Feb. 2, 2023

(54) DEVICE TO SUPPLY PRINTING MATERIAL

(71) Applicant: HEWLETT-PACKARD DEVELOPMENT COMPANY, L.P., Spring, TX (US)

(72) Inventor: Seung il KIM, Vancouver, WA (US)

(21) Appl. No.: 17/791,276

(22) PCT Filed: May 26, 2020
(86) PCT No.: PCT/US2020/034550

§ 371 Date: Jul. 7, 2022

(51) Int. Cl. B41J 2/175

(52) U.S. Cl. CPC B41J 2/17506

(57) ABSTRACT

A device to supply printing material to a printing material container of a printing apparatus may includes a chamber to store the printing material, a printing material outlet portion through which the printing material stored in the chamber is to be discharged, a plunger head to move in the chamber to discharge the printing material stored in the chamber through the printing material outlet portion, and a plunger handle disengaged from the plunger head and to engage the plunger head to move the plunger head to discharge the printing material.

### BACKGROUND

A printing apparatus performs printing using printing material such as toner. A printing apparatus includes a structure that may hold, store and/or contain printing material and supply or distribute/emit print material to be used by the printing apparatus in creating visual or tactile and/or three-dimensional prints or structures. For example, a printing apparatus may include a printing material container such as a removable/detachable printing cartridge that contains and supplies the printing material to be used by the printing apparatus to perform printing. When the printing material contained in the printing material container or the printing cartridge is exhausted, the printing cartridge may be decoupled and removed from a body of the printing apparatus, and a new printing cartridge may be inserted or coupled to the printing apparatus. The printing cartridge may also be supplied, resupplied, reloaded, or refilled with additional printing material.

### BRIEF DESCRIPTION OF THE DRAWINGS

FIG. 1 is a diagram of an example of a printing apparatus;

FIG. 1A illustrates an example of a printing apparatus to perform printing using liquid-based printing material;

FIG. 1B illustrates an example of a printing apparatus 1000 for an electric charge-based printing;

FIG. 2 is a perspective view of an example of an exterior of a printing apparatus to which a device to supply printing material can be joined to supply printing material;

FIG. 3 is a perspective view of a printing material container as a printing cartridge, according to an example;

FIG. 4 is a vertical cross-sectional view of a device to supply printing material according to an example;

FIG. 5 is an arrangement of a plunger handle, a plunger head and a printing material disperser according to an example;

FIGS. 6A, 6B, 6C and 6D illustrate an operation of the device according to an example;

FIG. 7 is a structural diagram of a first coupling portion and a second coupling portion according to an example;

FIGS. 8A, 8B and 8C illustrate examples of a printing material disperser according to an example;

FIGS. 9A and 9B illustrate the device containing printing material according to an example;

FIGS. 10A and 10B illustrate the device including a force exerting member according to an example;

FIGS. 11A and 11B illustrate exteriors of the device according to an example; and

FIG. 12 is a block diagram of a printing apparatus, according to an example.

### DETAILED DESCRIPTION

The printing cartridge may also be supplied with or refilled with new printing material by using a printing material supply device to supply printing material as a printing material refill kit.

In this disclosure, the term “refill” may be used for convenience in understanding the disclosure, and the term “refill” is not limited to a refill operation of filling printing material again after depleting the material but to be construed as a printing material supply operation in general and including the initial supply.

In this disclosure, when the specification states that one constituent element is “connected to” another constituent element, it includes a case in which the two constituent elements are connected to each other with another constituent element intervened therebetween as well as a case in which the two constituent elements are directly connected to each other. Further, the expressions “printing apparatus” and/or “image forming apparatus” as used herein includes an apparatus that processes printing data generated at a terminal such as a computer communicating through a wired connection or wirelessly, which may be a computer for personal and/or business use, a remote server communicating data across a network or the internet, and/or a wireless mobile device such as a smartphone or tablet, to perform printing on or in a medium or in a space. Examples of the printing apparatus may include particulate-based and liquid-based printers and 2D and 3D printing apparatuses. As used herein, the term “and/or” includes any and all combinations of one or more of the associated listed items. Expressions such as “at least one of,” when preceding a list of elements, modify the entire list of elements and do not modify the individual elements of the list.

Printing material is material used to print an image or an object using 2D and/or 3D printing technologies. Different types and forms of materials may be used as printing material. For example, printing material may be in a solid, liquid, colloidal, or gaseous form, or a combination thereof. The printing material may be non-biologic or biologic material, which may be living cells or any other biological compounds. For example, a solid or particulate form of printing material may include printing toner or metallic particulates, and a liquid form of printing material may include liquid-based ink such as ink for ink-jet printing. For example, printing material may be in a liquid form that may be curable to a different form such as a solid.

Reference will now be made in detail to examples, examples of which are illustrated in the accompanying drawings. According to an example, a device 9 to supply printing material to a printing material container 2 for a printing apparatus 1000 may be referred as a printing material refill kit 9, printing material replenishment kit 9, and/or a printing material refill kit 9, which is to supply printing material to a printing material container 2 for the printing apparatus 1000 such as a printing cartridge 2 installable in and coupleable to a printing apparatus 1000. The device 9 may be implemented for different types of printing materials, printing cartridges, printing apparatuses and printing principles. According to an example, a device 9 to supply printing material to a development cartridge 2 for an electric charge-based printing and liquid-based printing is disclosed. However, according to an example, such a device 9 as toner refill kit 9, toner replenishment kit 9, and/or a printing material refill kit 9 may be implemented for different types of printing materials, printing principles and printing apparatuses. For example, a device as a printing material refill kit may be implemented for a continuous toner supply.

The printing apparatus 1000 and the device 9 may include some or all of the features described in this disclosure.

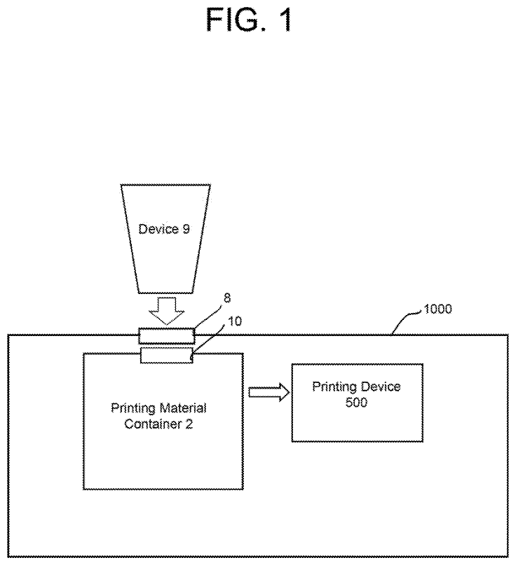

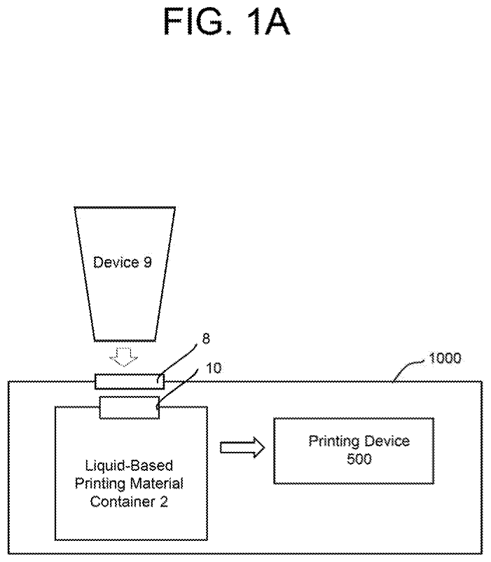

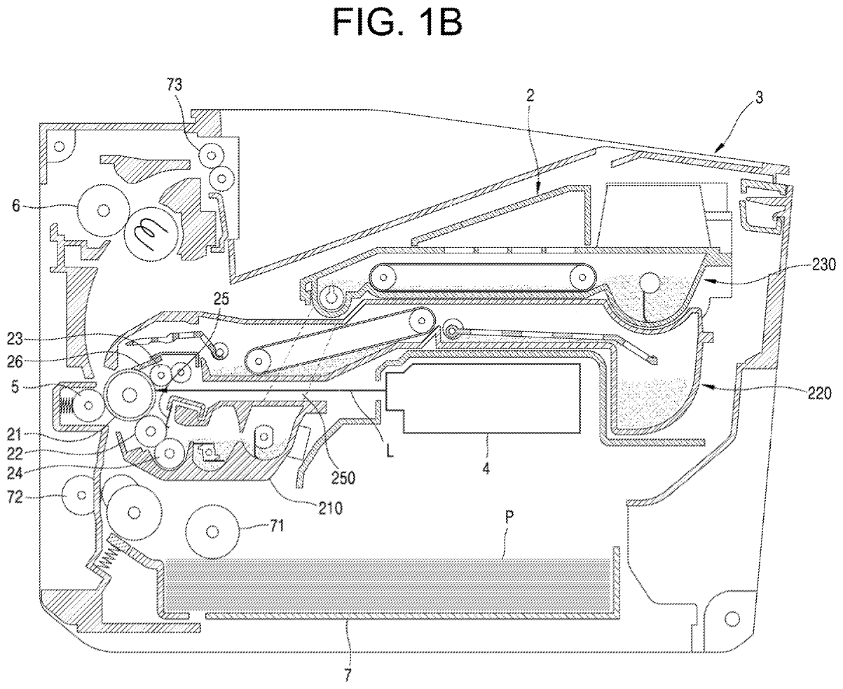

FIG. 1 is a diagram of an example of a printing apparatus 1000.

According to an example, referring to FIG. 1, the printing apparatus 1000 may include a printing device 500 to perform printing and a printing material container 2 to contain printing material, such as a printing cartridge 2. The printing material in the printing material container 2 may be supplied and/or transported to the printing device 500, such that the printing device 500 may process the supplied/transported printing material to perform printing. The device 9 containing printing material may be coupled to the printing material container 2 to supply printing material in the printing material container 2. The printing material container 2 may be filled, or refilled, or replenished with printing material supplied from the device 9. The printing material container 2 may include a printing material receiving portion 10 or a printing material receiving portion 10 to receive the supplied printing material from the device 9. The device 9 may be coupled directly to the printing material receiving portion 10 or printing material receiving portion 10 to supply printing material, when the printing material container 2 is placed in the printing apparatus 1000 or out of the printing apparatus 1000. According to an example, when the device 9 is coupled to the printing material receiving portion 10 or printing material receiving portion 10, the printing material receiving portion 10 may have some or all of the features of the communication portion 8 or the communication portion 8 described in this disclosure, and may function as the communication portion 8 or the communication portion 8. The device 9 may be coupled indirectly to the printing material receiving portion 10. For example, the printing apparatus 1000 may include a communication portion 8, and the device 9 may be coupled to the communication portion 8 to supply printing material to the printing material container 2 through the printing material receiving portion 10 connected to the communication portion 8. Different types of printing apparatuses and printing principles may be implemented to perform printing using printing material. According to an example, printing device 500 may perform printing, which may include an electric charge-based printing, an ink-jet based printing such as ink-jet printing with a moving nozzle or a static nozzle and high-speed or high-throughput ink-jet printing, printing based on thermal bonding, printing based on chemical bonding, 2D printing, 3D printing, and a combination thereof. Different types of printing apparatuses and materials may include printing apparatuses for personal use, office use, business use, and/or industrial scale and high volume-based printing applications.

For example, FIG. 1A illustrates an example of a printing apparatus 1000 to perform printing using liquid-based printing material. Referring to FIG. 1A, a printing apparatus 1000 to perform printing may include a printing device 500 to selectively deposit liquid-based printing material. The printing device 500 may include a variety of different suitable liquid application systems, such as ink-jet based system, which may include a thermal printing system which involves use of heat for achieving the ejection of liquid-based printing material. According to an example, the printing device 500 may include a charge controlled printing system in which electrostatic attraction is used for ejecting liquid-based printing material. According to an example, the printing device 500 may include a printing system that can use vibration pressure generated by a piezoelectric element for ejecting liquid-based printing material. For example, the printing device 500 may adopt an acoustic technique for the ejection of liquid-based printing material. In the acoustic technique, an electric signal is transformed into an acoustic beam and the compositions are irradiated by the acoustic beam so as to be ejected by radiation pressure.

According an example, a variety of different suitable liquid-based printing material application systems as the printing device 500 may include liquid-based printing material application systems employing those that are stationary during printing and span to form a printing zone, or a reciprocating printhead or nozzle, which, for diagrammatic purposes, may also be illustrated by the printing device 500.

According to an example, the printing device 500 may be implemented using one or any combination of the above mentioned examples of different suitable liquid-based printing material application systems.

FIG. 1B illustrates an example of a printing apparatus 1000 for an electric charge-based printing. Referring to FIG. 1B, a photosensitive drum 21 is an example of a photoconductor on which an electrostatic latent image is to be formed. For example, the photosensitive drum may include a cylindrical drum and a photoconductive photosensitive layer formed on an outer circumference of the drum. A charging roller 23 is an example of a component or material that charges a surface of the photosensitive drum 21 to have a uniform electric potential. A charge bias voltage may be applied to the charging roller 23. Instead of the charging roller 23, a corona charger (not shown) may be used. A developing roller 22 supplies printing material to an electrostatic latent image formed on a surface of the photosensitive drum 21 with beams or radiation of power or light to develop the electrostatic latent image.

According to an example, a two-component developing method may be used, in which printing material and a carrier are used as a developer. A carrier, which may be a substance that has specific magnetic or electrical properties, is commonly formed as spheres or hedrons or other geodesic shape that serve to be attracted to a magnetized substance and stack one upon another until the magnetic attraction to the magnetized substance is too weak to attract another carrier. The carrier may natively have an attractive property to print materials and serve to “carry” or collect and transfer the print material from one place to the electrostatically produced latent image where the print material is released from the carrier and temporarily attached to latent image until transferred to its intended substrate.

The developing roller 22 may be in the form of a sleeve inside of which a magnet is fixed. The sleeve may be located apart from the photosensitive drum 21 by tens to hundreds of micrometers. The carrier is attached to an outer circumference of the developing roller 22 via a magnetic force of a magnet, and printing material is attached to the carrier via an electrostatic force, which may form a form of a magnetic brush including the carrier and printing material on the outer circumference of the developing roller 22. According to a developing bias applied to the developing roller 22, only printing material is moved to the electrostatic latent image formed on the photosensitive drum 21.

In a one-component developing method in which printing material is used as a developer, the developing roller 22 may be in contact with the photosensitive drum 21, and may be located apart from the photosensitive drum 21 by a small measure, such as tens to hundreds of micrometers. In the example, a one-component contact developing method in which the developing roller 22 and the photosensitive drum 21 contacts each other to form a developing nip is used. The developing roller 22 may be in the form of an elastic layer (not shown) formed on an outer circumference of a conductive metal core (not shown). When a developing bias voltage is applied to the developing roller 22, printing material is moved via the developing nip, to the electrostatic latent image formed on a surface of the photosensitive drum 21 to be attached to the electrostatic latent image.

A supplying roller 24 attaches printing material to the developing roller 22. A supply bias voltage may be applied to the supplying roller 24 to attach printing material to the developing roller 22. A regulating member 25 regulating a printing material amount may be provided to be attached to the surface of the developing roller 22. The regulating member 25 may be, for example, a regulating blade having a front end that contacts the developing roller 22 at a certain pressure. A cleaning member 26 may be provided to remove residual printing material and foreign substances from the surface of the photosensitive drum 21 before charging. The cleaning member 26 may be, for example, a cleaning blade having a front end that contacts the surface of the photosensitive drum 21 at a certain pressure. Hereinafter, foreign substances removed from the surface of the photosensitive drum 21 will be referred to as waste printing material.

An optical projector 4 may be provided to project light modulated according to image information, onto a surface of the photosensitive drum 21 charged to a uniform electric potential. As the optical projector 4, for example, a laser unit that projects light radiated from a laser diode onto the photosensitive drum 21 by deflecting the light by using a polygon mirror, in the main scanning direction, may be used.

A transfer roller 5 is an example of a transfer unit that is located to face the photosensitive drum 21 to form a transfer nip. A transfer bias voltage used to transfer a printing material image developed on the surface of the photosensitive drum 21 to a print medium P is applied to the transfer roller 5. Instead of the transfer roller 5, a corona transfer unit may be used.

The printing material image transferred to a surface of the print medium P via the transfer roller 5 is maintained on the surface of the print medium P due to an attractive electrostatic force. A fusing or fixing unit 6 fuses the printing material image on the print medium P by applying heat and pressure to the printing material image, thereby forming a permanent print image on the print medium P.

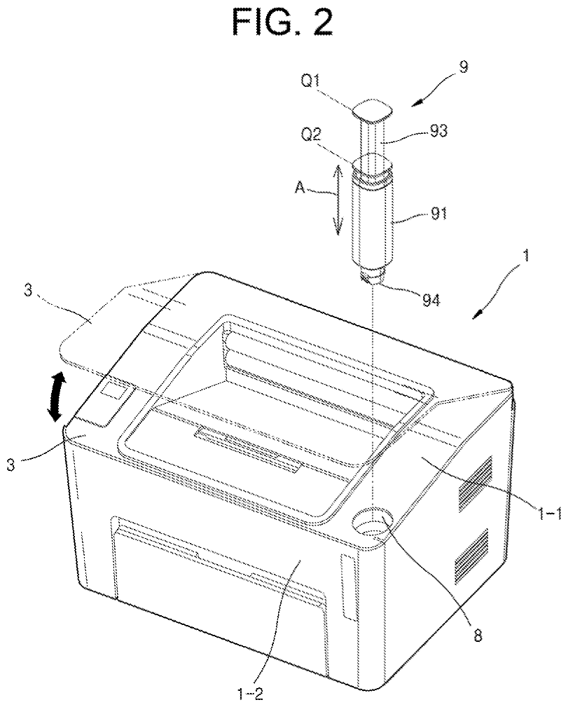

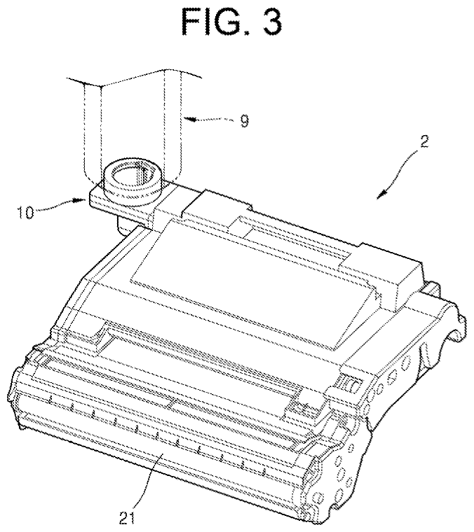

Referring to FIGS. 2B and 3, the printing material container 2 as a printing cartridge 2 according to the example may include a developing portion 210 in which the photosensitive drum 21 and the developing roller 22 are mounted, a waste container 220 receiving waste printing material removed from the photosensitive drum 21, and a printing material containing portion 230 connected to the developing portion 210 and containing printing material. In order to refill printing material in the printing material containing portion 230 as at least a portion of the printing material container 2, the printing material container 2 as a printing cartridge 2 includes a printing material receiving portion 10 connected to the printing material containing portion 230. The printing material receiving portion 10 provides an interface with respect to the printing material container 2 as a printing cartridge 2. According to an example, the printing material container 2 as a printing cartridge 2 may be an integrated type printing cartridge including the developing portion 210, the waste container 220, the printing material containing portion 230, and the printing material receiving portion 10.

A portion of an outer circumference of the photosensitive drum 21 is exposed outside a housing. A transfer nip is formed as the transfer roller 5 contacts an exposed portion of the photosensitive drum 21. At least one conveying member conveying printing material towards the developing roller 22 may be installed in the developing portion 210. The conveying member may also perform a function of charging printing material to a certain electric potential by agitating the printing material.

The waste container 220 may be located above the developing portion 210. The waste container 220 is spaced apart from the developing portion 210 in an upward direction to form a light path 250 therebetween. Waste printing material removed from the photosensitive drum 21 by using the cleaning member 26 is received in the waste container 220. The waste printing material removed from the surface of the photosensitive drum 21 is fed into the waste container 220. The shape and number of waste printing material feeding members are not limited. An appropriate number of waste printing material feeding members may be installed at appropriate locations to distribute waste printing material effectively in the waste container 220 by considering a volume or shape of the waste container 220.

The printing material containing portion 230 is connected to the printing material receiving portion 10 to receive printing material. The printing material containing portion 230 may be connected to the developing portion.

According to an example, a material supplying member may be used to supply printing material to the developing portion 210 from the printing material containing portion 230.

Referring to FIG. 1B, a charge bias is applied to the charging roller 23, and the photosensitive drum 21 is charged to a uniform electric potential. The optical projector 4 projects light modulated in accordance with image information, onto the photosensitive drum 21, thereby forming an electrostatic latent image on a surface of the photosensitive drum 21. The supplying roller 24 supplies printing material to a surface of the developing roller 22. The regulating member 25 may be provided to help to form a printing material layer having a uniform thickness on the surface of the developing roller 22. A developing bias voltage is applied to the developing roller 22. As the developing roller 22 is rotated, printing material conveyed to a developing nip is moved and adhered to the electrostatic latent image formed on the surface of the photosensitive drum 21 via the developing bias voltage, thereby forming a visible printing material image with the adhered printing material on the surface of the photosensitive drum 21. The print medium P may be withdrawn from a loading tray 7 by a pickup roller 71, transported and fed by a feeding roller 72 to the transfer nip where the transfer roller 5 and the photosensitive drum 21 face each other. When a transfer bias voltage is applied to the transfer roller 5, the adhered printing material in a form of the printing material image is transferred to the print medium P via an attractive electrostatic force. As the printing material image transferred to the print medium P receives heat and pressure from the fusing unit 6, the printing material image is fused to the print medium P. The print medium P may be discharged by using a discharge roller 73. The printing material that is not transferred to the print medium P but remains on the surface of the photosensitive drum 21 may be removed by using the cleaning member 26.

As described above, according to an example, referring to FIG. 1B, the printing material container 2 as a printing cartridge 2 supplies the printing material contained in the printing material containing portion 230 to the electrostatic latent image formed on the photosensitive drum 21 to form a visible printing material image, and is attachable to/detachable from the body 1. In addition, the printing material container 2 as a printing cartridge 2 includes the printing material receiving portion 10 used to refill printing material. The printing material receiving portion 10 may be integrated with the printing material container 2 as a printing cartridge 2 and thus may be exposed to the outside for accessibility or attachable to/detachable from the body 1 together with the printing material container 2 as a printing cartridge 2. According to the printing apparatus 1000 of the example, without removing the printing material container 2 as a printing cartridge 2 from the body 1, printing material may be refilled in the printing material container 2 while the printing material container 2 is mounted in the body 1. as printing material is refilled in the printing material containing portion 230 by using the printing material receiving portion 10, a replacement time of the printing material container 2 as a printing cartridge 2 may be extended, for example, until the lifetime of the photosensitive drum 21 ends, thereby reducing printing costs. In addition, printing material may be refilled while the printing material container 2 as a printing cartridge 2 is mounted in the body 1.

According to an example, FIG. 2 is a perspective view of the exterior of a printing apparatus 1000 according to an example.

FIG. 3 is a perspective view of a printing material container 2 as a printing cartridge 2, according to an example;

Referring to FIGS. 2 and 3, the printing apparatus 1000 may include a body 1 and a printing material container 2 as a printing cartridge 2 that is attachable to and detachable from the body 1. A door 3 may be provided in the body 1. The door 3 opens or closes an opening of the body 1 and may cover a portion of the body 1. While the door 3 opening and closing an upper portion of the body 1 is illustrated in FIG. 2, different arrangements of the door 3 may be implemented. For example, a door opening and closing a portion of the body, such as a side portion or a front portion of the body 1, may be included as needed. The printing material container 2 as a printing cartridge 2 may be coupled to or removed from the body 1 through an opening by the door 3.

According to an example, the device 9 may be directly couplable and/or connectable to the printing material receiving portion 10 of the printing material container 2 as a printing cartridge 2, for example, if the printing material receiving portion 10 is exposed to the outside and accessible directly. According to an example, the printing material container 2 as a printing cartridge 2 may be coupled to the printing apparatus 1000 and enclosed within the body 1 of the printing apparatus 1000. According to an example, the body 1 may include a communication portion 8 to communicate printing material through the body 1. The communication portion 8 may include a communication portion 8 through which a printing material receiving portion 10 of the printing material container 2 as a printing cartridge 2 can be accessed from the outside the body 1 while the printing material container 2 as a printing cartridge 2 is coupled to the body 1. According to an example, a communication portion 8 may be provided at a position of the body 1, such as a top portion or a side portion of the body 1. For example, the communication portion 8 may be provided at a position close to a front surface 1-2 of the body 1. When the front surface 1-2 faces the user, the user may access the communication portion 8. A printing material supply or refill operation using a device 9 may be performed through the communication portion 8. For example, the communication portion 8 may be provided on an upper surface 1-1 of the body 1. When the printing material container 2 as a printing cartridge 2 couples to the printing apparatus 1000, the printing material receiving portion 10 may be provided to be aligned with the communication portion 8. For example, the printing material receiving portion 10 may be provided under the communication portion 8. According to an example, the communication portion 8 and the printing material receiving portion 10 may be aligned with respect to different directions, such as vertical, horizontal or at an angled direction. The device 9 may access the printing material receiving portion 10 from above the body 1 through the communication portion 8.

Referring to FIG. 3, according to an example, the printing material container 2 as a printing cartridge 2 may be an integration-type printing cartridge 2 in which the printing material receiving portion 10 is integrated, as illustrated in FIG. 3. According to an example, the printing material container 2 as a printing cartridge 2 may be distributed during the product distribution stage while being mounted in the body 1. According to an example, the printing material container 2 as a printing cartridge 2 may be a consumable item that is replaceable and is to be replaced when the life of the printing material container 2 as a printing cartridge 2 ends, and may be distributed separately from the body 1.

According to an example, the printing apparatus 1000 may include the body 1, the printing material container 2 such as a printing cartridge 2 removable from the body 1, the printing material receiving portion 10 in the printing material container 2 such as a printing cartridge 2, and the controller 300. The printing material container 2 such as a printing cartridge 2 supplies printing material accommodated in the printing material containing portion 230 to an electrostatic latent image formed on a photoconductor to form a printing material image, the printing material container 2 such as a printing cartridge 2 being removable from the body 1. The printing material receiving portion 10 may be in the printing material container 2 such as a printing cartridge 2, and the device 9 for refilling printing material in the printing material containing portion 230 may be coupled to the printing material receiving portion 10. The controller 300 may control operations of the printing apparatus 1000 based on a connection between the printing material container 2 coupled to the body 1 and the device 9 coupled to the printing material receiving portion 10. The printing material receiving portion 10 may connect the device 9 coupled to the printing material receiving portion 10 to the body 1 through the interface between the printing material container 2 and the body 1. The printing material receiving portion 10 may be formed integrally with the printing material container 2.

According to an example, the device 9 may be coupled to the printing material receiving portion 10 through the communication portion 8 from the outer surface of the body 1 of the printing apparatus 1000 when the device 9 is inserted into the communication portion 8 from above the body 1, the device 9 may be coupled to the printing material receiving portion 10 as shown in FIG. 3. When the plunger handle 93 of the device 9 moves in the direction A of the chamber 91 toward the printing material outlet portion 94 in a state in which the device 9 is coupled to the printing material receiving portion 10, printing material accommodated in the chamber 91 may be discharged through a printing material outlet portion 94 such as a plug 94 or a port assembly 94 and supplied to the printing material containing portion 230 of the printing material container 2 through the printing material receiving portion 10. The device 9 may be removed from the communication portion 8 after completion of the printing material transfer.

Referring to FIG. 2, the device 9 may be a syringe-type printing material refill cartridge including a chamber 91 containing printing material and including a printing material outlet portion 94 and a plunger handle 93 that is movably coupled to the chamber 91 in a length direction A to push the printing material out of the chamber 91. The printing material outlet portion 94 may be provided at a front end portion of the chamber 91. In the syringe-type printing material device 9, the plunger handle 93 may be located at a top position Q1 (FIG. 1). The plunger handle 93 may be moved to a bottom position Q2 (FIG. 1).

For example, when the printing material device 9 is inserted into the communication portion 8 from above the main body 1 or inserted into the printing material receiving portion directly, as illustrated in FIG. 3, the printing material device 9 may be connected to the printing material receiving portion 10. While the printing material device 9 is mounted in the printing material receiving portion 10, the printing material received in the chamber 91 is discharged through the printing material outlet portion 94 to be supplied to the printing material container 2 of the development cartridge 2 through the printing material receiving portion 10. After printing material supplying or refilling is completed, the device 9 may be removed from the communication portion 8.

According to an example, as printing material is supplied or refilled in the printing material container 2 by using the printing material receiving portion 10, a replacement or service interval of the development cartridge 2 may be extended, for example, until the lifetime of the photosensitive drum 21 ends, thereby reducing printing costs per sheet and reducing service or maintenance time. In addition, printing material may be supplied or refilled while the development cartridge 2 is mounted in the main body 1, and thus, user convenience may be increased.

According to an example, in the case of particulate-based printing material, such as toner, the particulate-based printing material may be in a compacted state inside the device 9. For example, when the particulate-based printing material may be compacted to reduce the volume of the device 9 when not used—for example, when the device 9 is packaged for shipping. For example, two different or separated particulate components may be mixed before being plunged or discharged out of the device 9, for example, to prevent any premature chemical interactions between the particulate components or promote any chemical interactions before plunging or discharging. For example, when the device 9 is left unused for a long time, printing material in the chamber 91 may be compacted. In such a state, mobility of the printing material is very low and printing material may not be easily discharged through the printing material outlet portion 94 even when pressing the plunger handle 93. It is difficult to ensure sufficient printing material mobility of the compacted printing material just by shaking the device 9.

According to an example, in the case of liquid-based printing material, such as liquid ink, the liquid ink may be agitated or mixed before being plunged or discharged out of the device 9. For example, two different or separated liquid components may be mixed before being plunged or discharged out of the device 9, for example, to prevent any premature chemical interactions between the particulate components or promote any chemical interactions before plunging or discharging. For example, when the device 9 is left unused for a time period, liquid-based printing material in the chamber 91 may be affected by such a time period, for example, by sedimentation.

Thus, according to an example, a printing material disperser 95 may be placed inside the chamber 91 to resolve the compactness of the printing material. The compactness or the mixing/remixing of the printing material may be resolved by the printing material disperser 95 as the printing material disperser 95 moves through the printing material inside the chamber 91. In case of the particulate-based printing material according to an example, the printing material disperser 95 cuts through the toner to aerate the power for optimal flow thus improving the printing material loading or reloading experience.

According to an example, a device 9 to supply printing material to a printing material container 2 of a printing apparatus 1000 or an image forming apparatus 1000 may include a chamber 91 to store the printing material, a printing material outlet portion 94 through which the printing material stored in the chamber 91 is to be discharged, a plunger head 92 movable in the chamber 91 to discharge the printing material stored in the chamber 91 through the printing material outlet portion 94, the plunger head 92 including a first coupling portion 921, a plunger handle 93 having a second coupling portion 931 detached from the first coupling portion 921 and to couple to the first coupling portion 921, to engage the plunger handle 93 and the plunger head 92 to move the plunger head 92 by the plunger handle 93, to discharge the printing material stored in the chamber 91. The device 9 may include a printing material disperser 95 to be moved through the printing material stored in the chamber 91. The plunger handle 93 may move the printing material disperser 95 through the printing material stored in the chamber 91.

According to an example, a device 9 may include a chamber 91 to store the printing material, a printing material outlet portion 94 through which the printing material stored in the chamber 91 is to be discharged, a plunger head 92 to move in the chamber 91 to discharge the printing material stored in the chamber 91 through the printing material outlet portion 94, the plunger head 92 including a first coupling portion 921, and a plunger handle 93 disengaged from the plunger head 92 and to engage the plunger head 92 to move the plunger head 92 to discharge the printing material, the plunger handle 93 having a second coupling portion 931 detached from the first coupling portion 921 and to couple to the first coupling portion 921 to engage the plunger handle 93 and the plunger head 92. The device 9 may include a printing material disperser 95 to be moved through the printing material stored in the chamber 91. The plunger handle 93 may move the printing material disperser 95 through the printing material stored in the chamber 91.

According to an example, a device 9 may include a chamber 91 to store the printing material, a printing material outlet portion 94 through which the printing material stored in the chamber 91 is to be discharged, a plunger head 92 to move in the chamber 91 to discharge the printing material stored in the chamber 91 through the printing material outlet portion 94, the plunger head 92 including a first coupling portion 921, and a plunger handle 93 disengaged from the plunger head 92 and to engage the plunger head 92 to move the plunger head 92 to discharge the printing material, the plunger handle 93 having a second coupling portion 931 to couple to the first coupling portion 921 to engage the plunger handle 93 and the plunger head 92. The device 9 may include a printing material disperser 95 to be moved through the printing material stored in the chamber 91. The plunger handle 93 may move the printing material disperser 95 through the printing material stored in the chamber 91.

According to an example, a device 9 may include a chamber 91 to store the printing material, a printing material outlet portion 94 through which the printing material stored in the chamber 91 is to be discharged, a plunger head 92 movable within the chamber 91 to discharge the printing material stored in the chamber 91 through the printing material outlet portion 94,a plunger handle 93 detached from the plunger head 92 and movable to couple to the plunger head 92, and, after the plunger handle 93 couples to the plunger head 92, to move the plunger head 92 within the chamber 91 to discharge the printing material stored in the chamber 91, and a printing material disperser 95 movable by the plunger handle 93 in the chamber 91, to move through the printing material stored in the chamber 91 when the plunger handle 93 moves to couple to the plunger head 92.

According to an example, the device 9 may include a chamber 91 to store the printing material, a printing material outlet portion 94 through which the printing material stored in the chamber 91 is to be discharged, a plunger head 92 to move in the chamber 91 to discharge the printing material stored in the chamber 91 through the printing material outlet portion 94, a printing material disperser 95 to be moved through the printing material stored in the chamber 91, and a plunger handle 93 to move the printing material disperser 95 through the printing material stored in the chamber 91 and to engage the plunger head 92 to move the plunger head 92 to discharge the printing material. According to an example, the plunger head 92 may include a first coupling portion 921, and the plunger handle 93 may include a second coupling portion 931 detached from the first coupling portion 921 and to couple to the first coupling portion 921 to engage the plunger handle 93 and the plunger head 92.

According to an example, the plunger handle 93 may move the printing material disperser 95 through the printing material stored in the chamber 91, when the plunger handle 93 is disengaged from the plunger head 92.

According to an example, the first coupling portion 921 may include a one-way hook 901 and the second coupling portion 931 may include a hook accommodating portion 902 to accommodate the one-way hook to engage the plunger handle 93 and the plunger head 92.

According to an example, the second coupling portion 931 may include the one-way hook 901 and the first coupling portion 921 may include the hook accommodating portion 902 to accommodate the one-way hook to engage the plunger handle 93 and the plunger head 92.

According to an example, the printing material disperser 95 may include at least one dispersing rib 952 to move through the printing material when the plunger handle 93 moves the printing material disperser 95. According to an example, the printing material disperser 95 may include a protrusion 955 protruding from the at least one dispersing rib 952.

According to an example, the plunger head 92 may include at least one recessed portion 923 to accommodate the at least one dispersing rib 952 when the second coupling portion 931 couples to the first coupling portion 921 to engage the plunger handle 93 and the plunger head 92.

According to an example, the device 9 may include a force exerting medium 97 to exert force to move the second coupling portion 931 toward the first coupling portion 921.

According to an example, the force exerting medium 97 may include an elastic member 971 to exert the force to move the second coupling portion 931.

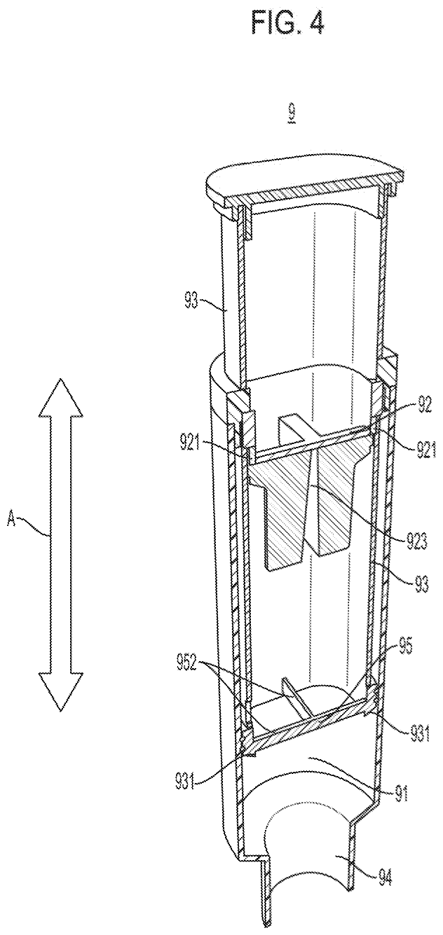

For example, FIG. 4 is a vertical cross-sectional view of the device 9 according to an example.

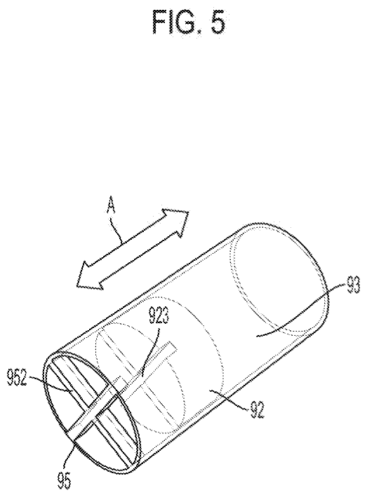

FIG. 5 is an arrangement of the plunger handle 93, the plunger head 92 and the printing material disperser 95 according to an example.

Referring to FIGS. 4 and 5, the chamber 91 is disposed to store printing material. The printing material outlet portion 94 may be provided, through which printing material is discharged. The plunger head 92 may be provided to move in the chamber 91 to discharge the printing material stored in the chamber 91 through the printing material outlet portion 94. A printing material disperser 95 may be provided to be moved through the printing material stored in the chamber 91. The plunger handle 93 may be provided to move the printing material disperser 95 through the printing material stored in the chamber 91 and to engage the plunger head 92 to move the plunger head 92 to discharge the printing material. For example, the plunger handle 93 may be movably inserted into the printing material chamber 91 in a length directions A.

According to an example, the plunger head 92 may be in a form of a piston 92 or a piston head 92 and may be placed at an upper portion of the chamber 91, to allow a space to store printing material in the chamber 91. The plunger head 92 may be initially placed to be stationary. The plunger handle 93 may be detached from the plunger head 92, such that the plunger handle 93 can be moved without moving the plunger head 92. According to an example, the plunger handle 93 may move to couple or attach to the plunger head 92 such that the plunger head 92 coupled to or attached to the plunger can be moved by the plunger head 92 to push the printing material out of the chamber 91, through the printing material outlet portion 94. According to an example, the plunger handle 93 is movably coupled to the chamber 91 to move in the length direction A.

According to an example, a portion of the plunger head 92 may closely contact an inner wall of the printing material chamber 91 to push the printing material toward the printing material outlet portion 94. For example, the portion of the plunger head 92 may include an elastic body such as silicone, plastic or rubber material that is to closely contact an inner wall of the printing material chamber 91, for example, rubber.

According to an example, the device 9 may include the printing material disperser 95 movable in the chamber 91 to disperse, agitate and/or mix printing material, for example, by moving through printing material when printing material is stored in the chamber 91. The printing material disperser 95 may be moved by the plunger handle 93. For example, the printing material disperser 95 may be connected to or coupled to the plunger handle 93. For example, the plunger handle 93 may include the printing material disperser 95. For example, the printing material disperser 95 may be attached to, fixed to, and/or integrated into the plunger handle 93.

According to an example, by the plunger handle 93, the printing material disperser 95 may move through printing material stored in the chamber 91 to disperse, agitate and/or mix printing material stored in the chamber 91, when the printing material chamber 91 stores printing material. For example, the plunger handle 93 may move the printing material disperser 95 through printing material stored in the chamber 91 to disperse, agitate and/or mix printing material stored in the chamber 91 when the plunger handle 93 is detached from the plunger head 92. For example, when the plunger handle 93 moves to engage or couple to the plunger head 92, the plunger handle 93 may move the printing material disperser 95 through printing material to disperse, agitate and/or mix printing material stored in the chamber 91. According to an example, the printing material disperser 95 may include at least one dispersing rib 952 to move through the printing material when the plunger handle 93 moves the printing material disperser 95. According to an example, the printing material disperser 95 may include a protrusion 955 protruding from the at least one dispersing rib 952.

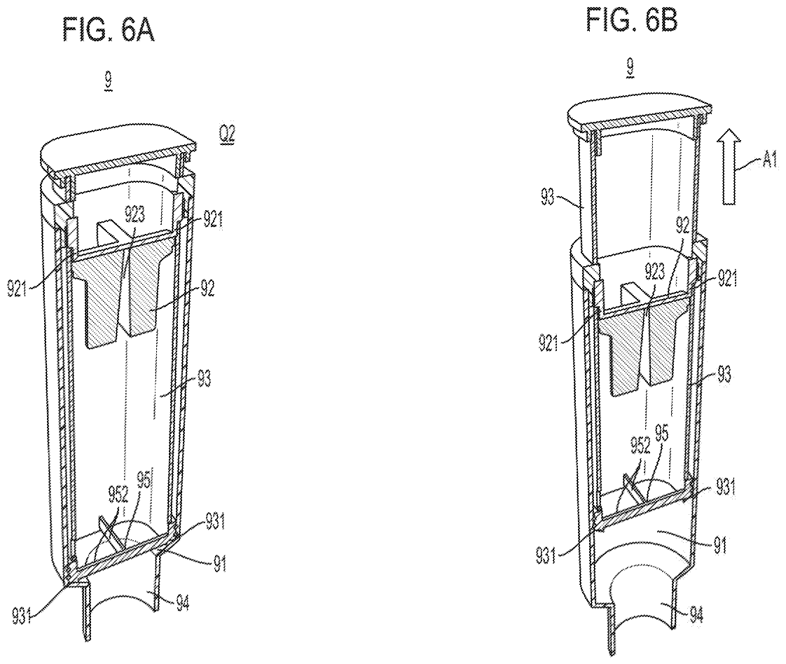

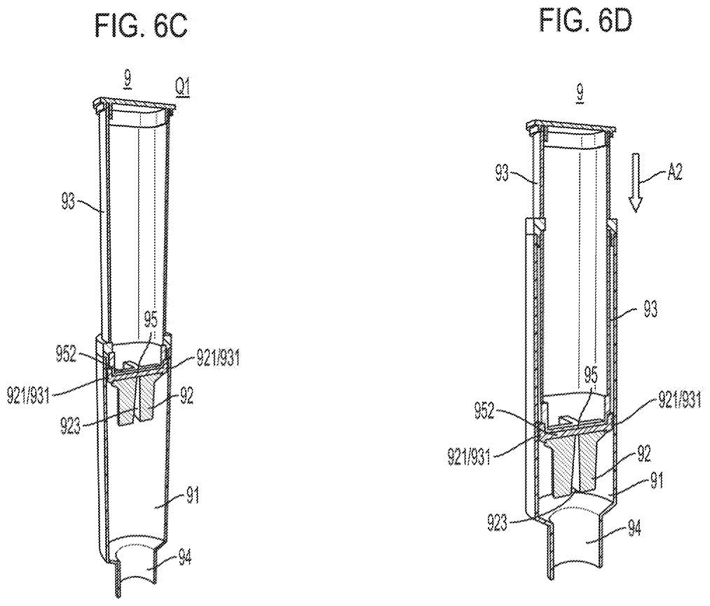

According to an example, the plunger head 92 may include at least one recessed portion 923 to accommodate the at least one dispersing rib 952. Referring to FIGS. 5, 6C and 6D, when the plunger handle 93 couples to the plunger head 92, the printing material disperser 95 may be accommodated or inserted into the at least one recessed portion 923. When the printing material disperser 95 is accommodated in the at least one recessed portion 923 may be considered as a part of the plunger including the plunger handle 93 and the plunger head 92 coupled. As such, the printing material disperser 95 is considered removed from the space where the printing material to be plunged is stored, thus clearing out the travel path of the plunger head 92 before the plunging. Accordingly, the printing material disperser 95 does not interfere with the plunging by the plunger head 92 during a plunging process.

According to an example, the plunger head 92 may include a first coupling portion 921, and the plunger handle 93 may include a second coupling portion 931 detached from the first coupling portion 921. The second coupling portion 931 may couple to the first coupling portion 921 to engage the plunger handle 93 and the plunger head 92.

When the device 9 is left unused for a long time as described above, printing material in the printing material chamber 91 may be compacted. Then, gaps between printing material particles are reduced. In this state, printing material mobility is very low, and thus, printing material is not easily discharged.

FIGS. 6A, 6B, 6C and 6D illustrate of operation of the device according to an example.

According to an example, FIG. 6A illustrates the device 9 with the plunger handle 93 is detached or decoupled from the plunger head 92 and placed at or around the bottom position Q2. Referring to FIG. 6A, the plunger head 92 may be provided or disposed at or around the upper position of the chamber 91. According to an example, the plunger head 92 at or around the upper position of the chamber 91 may be placed to be movable. According to an example, the plunger head 92 may be initially provided or disposed to be stationary at or around the upper position of the chamber 91 away from the printing material outlet portion 94. When the plunger handle 93 is at or around the position Q2, the printing material disperser 95 may be placed at or around the bottom portion of the chamber 91, and printing material can be stored in-between the plunger head 92 at the upper portion of the chamber 91 and the printing material disperser 95. According to an example, the printing material disperser 95 may be attached to, fixed to, and/or integrated into the plunger handle 93. According to an example, when the plunger handle 93 is detached or decoupled from the plunger head 92, the plunger handle 93 can move independently of the plunger head 92 until the plunger handle 93 couples to the plunger head 92, which allows more ways of structural arrangements in the device 9. For example, when the chamber 91 stores printing material, the plunger handle 93 does not need to be placed to provide a space for the printing material—for example, at the top position Q2—but can be placed at different positions such as the lowest position Q1, and allowing storing the printing material between surfaces of the chamber 91 and the plunger head 92, regardless of the position of the plunger handle 93. For example, printing material can be stored in the chamber 91 even when the plunger handle is at the lowest position Q2, reducing the total volume or size of the device 9 even when the device 9 stores printing material to be plunged by the plunger head 92 and plunger handle 93, which enables less volume required for handling such as packing and/or shipping.

FIG. 6B illustrates the plunger handle 93 moving in the direction Al. According to an example, the plunger handle 93 may be moved by being pulled or pushed manually, or by receiving force or power from another device or component. Referring to FIG. 6B, the printing material disperser 95 may move along with the plunger handle 93 in the direction Al and across the space in the chamber 91. When the printing material disperser 95 moves across the space in the chamber 91, and when printing material is stored in the chamber 91, at least a portion of the printing material disperser 95 may move through the printing material to disperse, agitate and/or mix printing material stored in the chamber 91

FIG. 6C illustrates the plunger handle 93 being at the top position Q1. Referring to FIG. 6C, the plunger handle 93 may couple to the plunger head 92 at or around the top position Q1. After the plunger handle 93 couples to the plunger head 92, the plunger handle 93 can move the plunger head 92 based on this coupling 921/931. According to an example, the plunger head 92 may include the first coupling portion 921, and the plunger handle 93 may include the second coupling portion 931 coupleable to the first coupling portion 921. When the plunger handle 93 couples to the plunger head 92, the second coupling portion 931 detached from the first coupling portion 921 couples to the first coupling portion 921, coupling the plunger handle 93 and plunger head 92 via the coupled first and second coupling portions 921/931. When the plunger handle 93 couples to the plunger head 92, the printing material disperser 95 may be accommodated or inserted in the at least one recessed portion 923. When the printing material disperser 95 is accommodated in the at least one recessed portion 923, the printing material disperser 95 may be removed from the space where the printing material to be plunged is stored.

FIG. 6D illustrates the plunger handle 93 coupled to the plunger head 92 and has moved in the A2 direction. According to an example, as the plunger handle 93 coupled to the plunger head 92 moves in the A2 direction, the coupled plunger head 92 is also moved or pushed by the plunger handle 93 in the A2 direction. As the plunger head 92 is moved or pushed, the plunger head 92 moves through the chamber 91 in the A2 direction. When printing material is stored in the chamber 91, the plunger head 92 is moved or pushed by the plunger handle 93, plunging the printing material through the printing material outlet portion 94.

According to an example, a selective coupling of the decoupled or detached plunger handle 93 and plunger head 92 may allow more flexibility and/or more structural arrangements in designing the device 9. For example, when printing material is stored in the chamber 91 even when the plunger handle can be moved to the lowest position Q2, reducing the total volume or size of the device 9 even when the device 9 stores printing material to be plunged by the plunger head 92 and plunger handle 93, which can allow less volume required for handling such as packing and/or shipping.

According to an example, various structures and mechanical engineering concepts may be implemented as the first coupling portion 921 and the second coupling portion 931 coupleable to the first coupling portion 921. For example, structures for the first coupling portion 921 and eh second coupling portion 931 may include male and female coupling structures such as a hook or bump.

For example, FIG. 7 is a structural diagram of the first coupling portion 921 and the second coupling portion 931 according to an example. Referring to FIG. 7, the second coupling portion 931 may include an one-way hook 901, and the first coupling portion 921 may include a hook accommodating portion 902. When the plunger handle 93 moves to couple to the plunger head 92, the one-way hook 901 may have a lower angled surface or first surface having a shape to facilitate the insertion, joining or coupling of the one-way hook to the hook accommodating portion 902 in a first direction. Once the one-way hook couples to the hook accommodating portion 902, the one-way hook may have a higher-angled surface or a second surface having a shape to resist the decoupling of the one-way hook 901 from the hook accommodating portion 902, for example, relative to the first surface. According to an example, the one-way hook 901 may facilitate the coupling of the first coupling portion 921 and the second coupling portion 931 in the direction A1 and may resist the decoupling, detaching, or separating of the first coupling portion 921 and the second coupling portion 931 in the direction A2.

According to an example, the plunger handle 93 may include a handle sealing portion 903 to suppress or discourage the printing material from exiting through any gap in-between surfaces of the plunger handle 93 and the chamber 91. For example, referring FIG. 7, a lower portion of the plunger handle 93 may include the handle sealing portion 903. For example, the handle sealing portion 903 may be adjacent or contract an inner surface of the chamber 91, to seal a gap between surfaces of the plunger handle 93 and the chamber 91 and suppress any printing material leak through this gap.

According to an example, the printing material disperser 95 may include a various structure to disperse, agitate or mix the printing material by moving through the printing material. For example, the printing material disperser 95 may include at least one rib having various shapes, such as cross-sectional shapes to further facilitate the dispersion, agitation or mixing of the printing material. For example, the printing material disperser 95 may include a plurality of ribs. For example, a rib among the plurality of ribs may or may not intersect with another rib among the plurality of ribs. For example, a rib among the plurality of ribs may have one or more branching with one or more protrusions. For example, the printing material disperser may include a structure in forms of mesh or a grid.

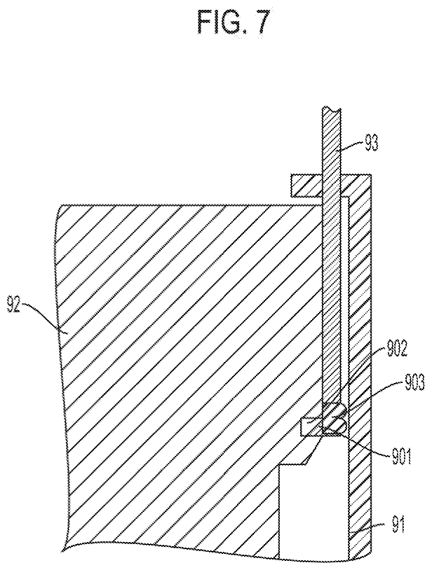

For example, FIGS. 8A, 8B and 8C illustrate examples of a printing material disperser 95 according to an example. Referring to FIG. 8A, a rib 952 may intersect with another rib 952. Referring to FIG. 8C, a plurality of ribs 952 may insect at or around the same location. Referring to FIG. 8B, a plurality of ribs 952 may respectively include at least one protrusion 955.

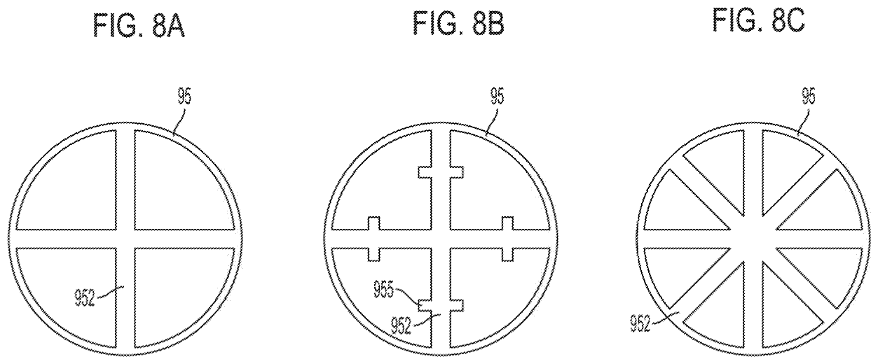

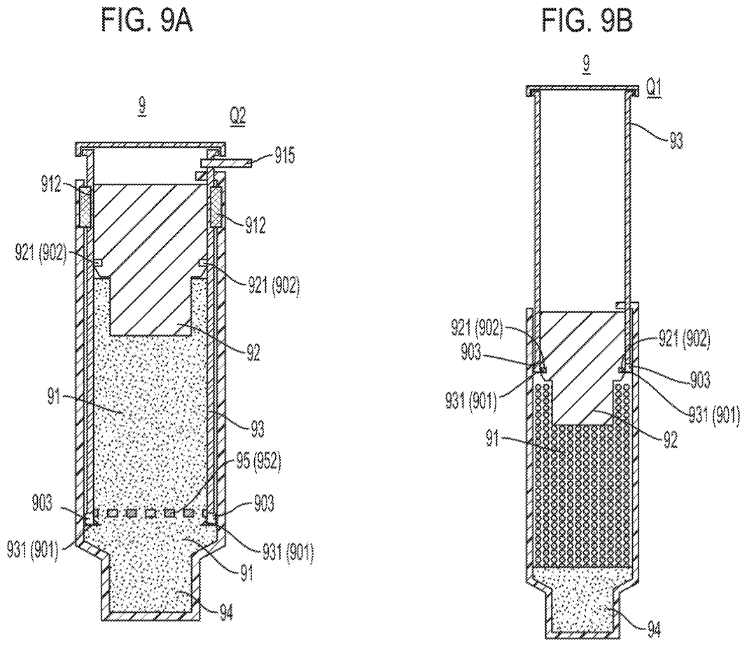

FIGS. 9A and 9B illustrate the device 9 containing printing material according to an example. FIG. 9A illustrates the device 9 storing printing material with the plunger handle 93 detached from the plunger head 92. For example, the device 9 may be in an initial or packaged state as shown in FIG. 9A, where the plunger handle 93 detached from the plunger head 92 is placed at the lowest position Q2. According to an example, the device 9 may include chamber seal 912 to further seal the chamber 91 in the initial state to suppress printing material leak. According to an example, a handle lock pin 915 may be removable provided to lock the plunger handle at the Q2 position. According to an example, the chamber seal 912 and the handle lock pin 915 may be removed before moving the plunger handle, for example, in the Al direction. FIG. 9B illustrates the device 9 prepared for plunging the printing material stored in the chamber 91. According to an example, referring FIG. 9B, the plunger handle 93 may be moved to the Q1 position by manually pulled. As the plunger handle is being pulled, the printing material disperser 95 may move through the printing material to, for example, to disperse the printing material such that the printing material can be dispersed throughout chamber 91 to facilitate the plunging of the printing material. The handle seal 903 may suppress printing material leak when the plunger handle 93 moves towards the top position Q1.

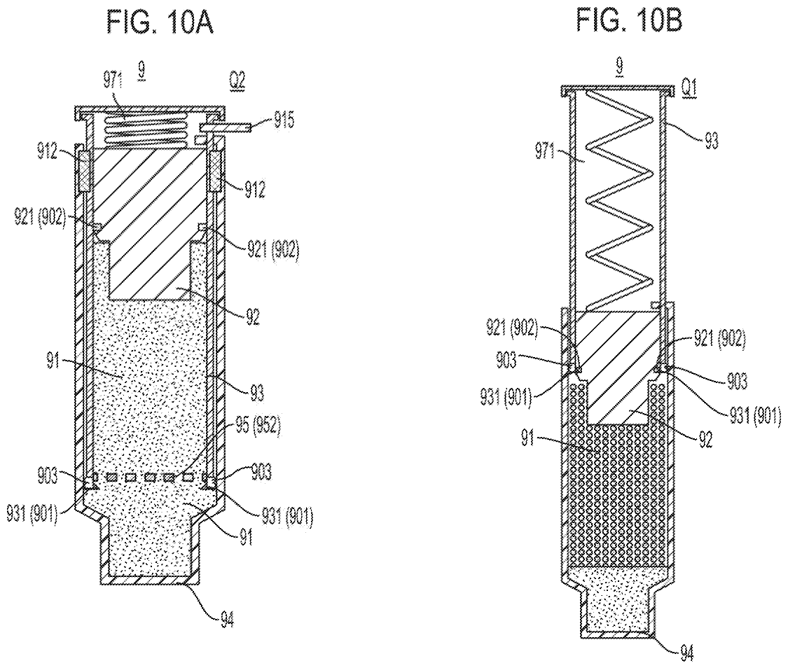

According to an example, the plunger handle 93 may be moved or pulled to the position Q1 manually, for example, by a user using the device 9. According to an example, power or force may be supplied or exerted internally or externally by a power supply or a device or a component, to move the plunger handle 93 to the position Q1. For example, a motor to drive the device 9 and/or the plunger handle 93 may be provided external to the device 9 or internally in the device 9. For example, FIGS. 10A and 10B illustrate the device including force exerting member 971. According to an example, the force exerting member 971 may include an elastic member 971, such as a spring or rubber. According to an example, the plunger handle 93 may be moved to the position Q1 by gas or liquid pressure.

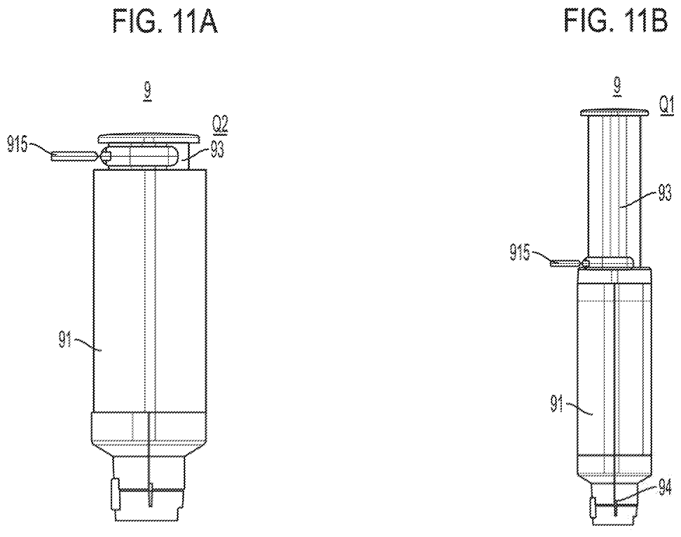

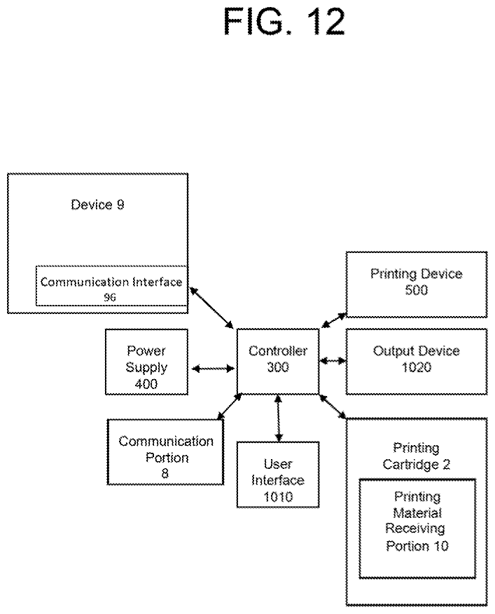

FIGS. 11A and 11B illustrate exteriors of the device 9 according to an example. As shown in FIGS. 11A and 11B, a selective coupling of the decoupled or detached plunger handle 93 and plunger head 92 may allow more flexibility and/or more structural arrangements in designing the device 9. For example, printing material can be stored in the chamber 91 even when the plunger handle is at the lowest position Q2, reducing the total volume or size of the device 9 even when the device 9 stores printing material to be plunged by the plunger head 92 and plunger handle 93, which can allow less volume required for handling such as packing and/or shipping.

The printing apparatus 1000 may have an electrical structure, which may be for detecting whether the device 9 is coupled to the printing material receiving portion 10, and/or, through which information associated with the device 9 may be obtainable.

According to an example, referring to FIG. 14, the device 9 may include a communication interface 96 for communication between the device 9 and the controller 300. According to an example, the communication interface 96 may communicate with the controller wirelessly or through a wired connection. For example, the controller 300 may determine whether or not the device 9 is mounted based on information on the connection status of the device 9 to the communication portion 8 or the printing material receiving portion 10.

According to an example, the device 9 may include signal completion signal generator to indicate completion of the transfer of printing material.

The printing material receiving portion 10 or the communication portion 8 may be electrically connected to the device 9 coupled to the printing material receiving portion 10 and the body 1 and may transmit the information about the device 9 and the information about the printing material container 2 to the controller 300 through the interface between the printing material container 2 and the body 1. The information about the device 9 may include information for authentication of the device 9 and the information about the printing material container 2 may include information for authentication of the printing material container 2. The controller 300 may control operations of the printing apparatus 1000 based on signals or information received through a plurality of electrical contacts. The controller 300 may be a controller for a printing apparatus 1000. The controller 300 may be a controller implemented in the printing apparatus, for example, as a separate controller or integrated with the controller of the printing apparatus 1000. The controller 300 may be physically separated from the printing apparatus, such as an independent remote controller, a client device or a server in communication with the printing apparatus.

FIG. 14 is a block diagram of a printing apparatus 1000 according to an example. With reference to FIG. 14, the printing apparatus 1000 may also include a user interface 1010 which provides a user with information regarding whether the device 9 is coupled to the printing material receiving portion 10. By providing such information to a user, the user can know whether the device 9 is successfully or unsuccessfully coupled to the printing material receiving portion 10. When the device 9 is coupled to the printing material receiving portion 10 and ready or aligned to discharge and transfer printing material to the printing material container 2, power can be delivered to the device 9 to perform a plunging operation to discharge the printing material from the device 9 to the printing material container 2. When the device 9 is not fully coupled to the printing material receiving portion 10 or not aligned to discharge printing material to the printing material container 2, power may not be delivered to the device 9 to avoid an erroneous operation.

When the device 9 is coupled to the printing material receiving portion 10, the device 9 may be connected to the controller 300. The controller 300 may read information about the device 9 from the device 9. The information about the device 9 may include information for authentication of the device 9. Therefore, the controller 300 may receive the information about the device 9. The controller may also receive the information about the printing material container 2 through the interface between the printing material container 2 and the controller 300.

According to an example, the printing material receiving portion 10 may include an alignment detection sensor to detect that the device 9 coupled to the printing material receiving portion 10 enters a certain position depending on the alignment of the device 9. The printing material receiving portion 10 may transmit whether or not the mounted device 9 has reached a certain position by rotation to the controller 300, based on a result of the detection of the device 9. For example, the printing material receiving portion 10 may transmit a signal indicating that the device 9 is improperly coupled to the printing material receiving portion 10 or not aligned to discharge printing material to the printing material container 2, that the device 9 is arranged to discharge and transport printing material, and/or that the printing material receiving portion 10 is ready to receive printing material from the device 9 when the device 9 is aligned to discharge printing material.

According to an example, the controller 300 may communicate with at least one among the printing material container 2 including the printing material receiving portion 10, the communication portion 8, the device 9, and the power supply 400. According to an example, a controller to meter, detect or measure an amount of printing material supplied by the device. For example, the controller 300 may meter an amount of printing material in the printing material container 2. For example, the controller 30 may meter the amount of printing material in the device 9. For example, the controller 300 may control power supply 400 to control the device 9 to supply printing material to the printing material container 2, based on information received from at least one among the printing material container 2 including the printing material receiving portion 10, the communication portion 8, the device 9, and the power supply 400.

According to an example, the plunger handle 93 is movable based on an amount of printing material contained in the printing material chamber 91. According to an example, referring to FIGS. 15a and 15b, the plunger handle 93 as a piston handle 93 may be to move based on an amount of printing material contained in the printing material container 2 before the transfer of the printing material contained in the chamber 91. According to an example, the controller 300 may control a process of printing material refill process, such as initiation and completion of the printing material refill process. For example, referring to FIGS. 14 and 15a-15b, the printing apparatus 1000 may include a controller 300 to control an amount of printing material supplied by the device 9, based on an amount of printing material in the printing material container 2. The controller 300 may be to control the amount of printing material supplied by the device 9, based on the amount of printing material in the device 9. According to an example, various types of sensors may be provided. For example, a sensor 310 to detect an amount of toner in the printing material container 2 may be provided. Different types of sensors to detect the amount of toner may be implemented, including a weight sensor and an optical sensor. According to an example, the controller may calculate an amount of printing material consumed by the printing apparatus 1000 based on a printing task of the printing apparatus 1000. For example, the controller may calculate an amount of printing material consumed by the printing apparatus 1000 based on the printing data used to perform the printing task. For example, the controller 300 may calculate how much printing material in the printing material container 2 is consumed by counting the number of pixels of an image indicated in an image data used for printing an image on a printing medium. According to an example, the device 9 may provide information to indicate an amount of toner that can be discharged and transferred to the printing material container 2. Based on such various information and detections by the sensor 310, the controller 300 may determine an amount of printing material to be discharged and transferred from the device 9 to the printing material container 2, and may control the printing apparatus according to a result of the detection. For example, the controller 300 may control to initiate and stop supply power to the device 9.

In order to remove the device 9, the device 9 may be rotated in a direction opposite to a direction in which the device 9 is rotated after being coupled to the printing material receiving portion 10.

The printing apparatus 1000 may be controlled to output information regarding the device 9 being separated from the printing material receiving portion 10. For example, a message may be presented on a screen of the user interface 1010 regarding a status of alignment or separation of the device 9, or a light indication may be provided. Further the output may be in the form of haptic feedback presented through the user interface 1010, or a sound generated by an output device 1020 such as a speaker, which may also provide a user information regarding separation of the device 9 from the printing material receiving portion 10. The user interface 1010 and output device 1020 may be combined as a single device where the user interface 1010 includes the output device 1020 or vice versa.

While various examples have been described with reference to the drawings, it will be understood that various changes in form and details may be made therein without departing from the spirit and scope as defined by the following claims.

What is claimed is:

1. A device to supply printing material to a printing material container of a printing apparatus, the device comprising:
a chamber to store the printing material;
a printing material outlet portion through which the printing material stored in the chamber is to be discharged;
a plunger head to move in the chamber to discharge the printing material stored in the chamber through the printing material outlet portion, the plunger head including a first coupling portion; and
a plunger handle disengaged from the plunger head and to engage the plunger head to move the plunger head to discharge the printing material, the plunger handle having a second coupling portion to couple to the first coupling portion to engage the plunger handle and the plunger head.

2. The device according to claim 1, further comprising a printing material disperser to be moved through the printing material stored in the chamber,
wherein the plunger handle is to move the printing material disperser through the printing material stored in the chamber.

3. The device according to claim 2, wherein the plunger handle is to move the printing material disperser through the printing material stored in the chamber when the plunger handle is disengaged from the plunger head.

4. The device according to claim 1, wherein
the first coupling portion includes an one-way hook, and the second coupling portion includes a hook accommodating portion to accommodate the one-way hook to engage the plunger handle and the plunger head, or
the second coupling portion includes the one-way hook, and the first coupling portion includes the hook accommodating portion to accommodate the one-way hook to engage the plunger handle and the plunger head.

5. The device according to claim 2, wherein the printing material disperser includes at least one dispersing rib to move through the printing material when the plunger handle moves the printing material disperser.

6. The device according to claim 5, wherein the printing material disperser includes a protrusion protruding from the at least one dispersing rib.

7. The device according to claim 5, wherein the plunger head includes at least one recessed portion to accommodate the at least one dispersing rib when the second coupling portion couples to the first coupling portion to engage the plunger handle and the plunger head.

8. The device according to claim 1, further comprising a force exerting medium to exert force to move the second coupling portion toward the first coupling portion.

9. The device according to claim 8, wherein the force exerting medium includes an elastic member to exert the force to move the second coupling portion.

10. A device to supply printing material to a printing material container of a printing apparatus, the device comprising:
a chamber to store the printing material;
a printing material outlet portion through which the printing material stored in the chamber is to be discharged;
a plunger head to move in the chamber to discharge the printing material stored in the chamber through the printing material outlet portion;
a printing material disperser to be moved through the printing material stored in the chamber; and
a plunger handle to:
move the printing material disperser through the printing material stored in the chamber, and
engage the plunger head to move the plunger head to discharge the printing material.

11. The device according to claim 10, wherein
the plunger head includes a first coupling portion, and
the plunger handle include a second coupling portion detached from the first coupling portion and to couple to the first coupling portion to engage the plunger handle and the plunger head.

12. The device according to claim 10, wherein the plunger handle is to move the printing material disperser through the printing material stored in the chamber when the plunger handle is disengaged from the plunger head.

13. The device according to claim 11, wherein
the first coupling portion includes an one-way hook and the second coupling portion includes a hook accommodating portion to accommodate the one-way hook to engage the plunger handle and the plunger head, or
the second coupling portion includes the one-way hook and the first coupling portion includes the hook accommodating portion to accommodate the one-way hook to engage the plunger handle and the plunger head.

14. The device according to claim 10, wherein the printing material disperser includes at least one dispersing rib to move through the printing material when the plunger handles moves the printing material disperser.

15. The device according to claim 11, further comprising a force exerting medium to exert force to move the second coupling portion toward the first coupling portion.
